(19) United States
(12) Patent Application Publication
(10) Pub. No.: US 2023/0272832 A1
(43) Pub. Date: Aug. 31, 2023

(54) CLUTCH ASSEMBLY INCLUDING WET FRICTION MATERIAL WITH COLLOIDAL SILICA COATING

(71) Applicant: Schaeffler Technologies AG & Co. KG, Herzogenaurach (DE)

(72) Inventors: Kayla Covington, Dalton, OH (US); Michael Yanetta, Valley City, OH (US); Murat Bakan, Canton, OH (US)

(21) Appl. No.: 17/681,307

(22) Filed: Feb. 25, 2022

(51) Int. Cl. F16D 69/02; F16D 13/64

(52) U.S. Cl. CPC F16D 69/026; F16D 69/023; F16D 13/64; F16D 2200/0091; F16D 2200/0047; F16D 2200/0069

(57) ABSTRACT

A clutch assembly for a motor vehicle drivetrain includes a rigid support and a wet friction material fixed to a surface of the rigid support. The wet friction material includes a base material including a matrix of fibers and filler particles embedded in the matrix of fibers; a binder embedded in the base material; and a colloidal silica coating applied onto an outer surface of the base material.

The present disclosure relates generally to friction clutches and plates used in torque converters and other motor vehicle drivetrain components and more specifically to a clutch assembly including a wet friction material.

### BACKGROUND

The friction material in wet-type friction clutches generally operates in an oil submerged environment and is often paper-based material used to form friction material rings. It is known to form the friction material by a paper making process using a Fourdrinier machine.

### SUMMARY

A clutch assembly for a motor vehicle drivetrain includes a rigid support and a wet friction material fixed to a surface of the rigid support. The wet friction material includes a base material including a matrix of fibers and filler particles embedded in the matrix of fibers; a binder embedded in the base material; and a colloidal silica coating applied onto an outer surface of the base material.

In some embodiments of the clutch assembly, the binder embedded base material may include, by percent weight, 25 to 45% fibers, 25 to 40% filler material and 25 to 40% binder. The filler material may include calcined kaolin clay. The binder embedded base material may include, by percent weight, 25 to 45% fibers, 10 to 20% diatomaceous earth, 15 to 30% calcined kaolin clay and 30 to 40% tung oil modified phenolic resin. The binder embedded base material may include, by percentage weight, 28 to 38% fibers, 28 to 38% filler material and 30 to 35% binder. The binder embedded base material may include, by percent weight, 28 to 38% fibers, 10 to 20% diatomaceous earth, 18 to 28% calcined kaolin clay and 30 to 40% tung oil modified phenolic resin. The binder embedded base material may include, by percent weight, 28 to 38% fibers, 8 to 18% diatomaceous earth, 15 to 25% calcined kaolin clay and 30 to 35% tung oil modified phenolic resin. The binder embedded base material may include, by percentage weight, 20 to 35% cellulose fibers, 5 to 15% aramid fibers, 20 to 35% diatomaceous earth and/or calcined kaolin clay, 1 to 5% carbon fibers, 1 to 15% graphite, and 30 to 35% phenolic resin. The binder embedded base material may include, by percentage weight, 25 to 30% cellulose fibers, 5 to 10% aramid fibers, 25 to 35% diatomaceous earth and/or calcined kaolin clay, 2 to 4% carbon fibers, 1 to 5% graphite, and 30 to 35% phenolic resin. The colloidal silica coating may be formed of colloidal silica particles having a mean diameter of 20 to 25 nm.

A method of making a clutch assembly for a motor vehicle is also provided. The method includes fixing a wet friction material to a surface of a rigid support; providing a base material including a matrix of fibers and filler particles and a binder embedded in the matrix of fibers; and applying a colloidal silica containing solution on an outer surface of the base material to form a colloidal silica coating on the base material.

In some embodiments of the method, the fixing of the wet friction material to the surface of the rigid support may include attaching the base material to the rigid part to provide a cured base material on the rigid part, and the colloidal silica containing solution is applied on the outer surface of the base material to form the colloidal silica coating on the cured base material after the attaching of the base material to the rigid part. The method may further include curing the binder prior to the applying of the colloidal silica containing solution on the outer surface of the base material to form the colloidal silica coating on the base material. The colloidal silica containing solution may include, by percent weight, 30 to 50% by weight of colloidal silica and 50 to 60% by weight of water. Particles of the colloidal silica may have a spherical shape and may be non-porous. Particles of the colloidal silica may have a mean diameter of 20 to 25 nm. The applying of the colloidal silica containing solution on the outer surface of the base material to form the colloidal silica coating on the base material may include applying 1 to 10 mg/cm2 of the suspension the base material. The base material may include, by percent weight, 30 to 45% fibers, 25 to 35% filler material, 1 to 15% friction modifiers and 25 to 40% binder.

A method of making a wet friction material layer includes providing a base material including a matrix of fibers and filler particles and a binder embedded in the matrix of fibers; and applying a colloidal silica containing solution on an outer surface of the base material to form a colloidal silica coating on the base material.

### BRIEF DESCRIPTION OF THE DRAWINGS

The present disclosure is described below by reference to the following drawings, in which:

FIG. 1a schematically shows wet friction material with a binder is added to a material base;

FIG. 1b schematically shows the binder saturated base material and a rigid part joined together to form a friction assembly;

FIG. 1c schematically shows a colloidal silica containing solution applied to the base material to form a colloidal silica coating on the base material.

FIG. 2 shows a graph illustrating the advantages of coating the base wet friction material with a colloidal silica coating;

FIG. 3 shows a wet friction material layer bonded to clutch plates in a clutch pack; and

FIG. 4 shows a wet friction material layer bonded to a clutch plate in a torque converter

### DETAILED DESCRIPTION

Next generation wet friction materials for electric and hybrid applications need to provide higher torque which requires a higher friction coefficient. To achieve this the friction material will need to reach and maintain the desired friction coefficient.

The present disclosure provides a friction material with a base material formed fibers, fillers, a binder and optionally one or more friction modifiers. The base material is coated with a colloidal silica coating to achieve higher friction coefficients, and to stabilize the friction coefficient over various pressures and temperatures.

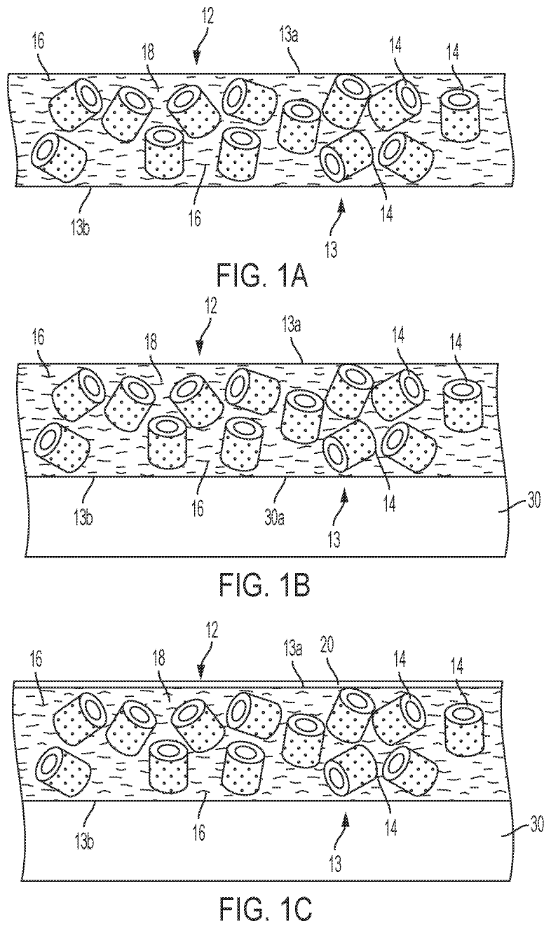

FIGS. 1a to 1c schematically illustrate a method of forming a wet friction material in accordance with an embodiment of the present disclosure.

A wet friction material 12 includes a base material 13 formed of fibers, filler material and a binder. The fibers can be aramid fibers, cellulose fibers and/or carbon fibers. The cellulose fibers can be in cotton linter or wood pulp form. The filler material may be particles of diatomaceous earth and calcined kaolin clay. The binder may be a phenolic resin. Optionally a friction modifier such as graphite may also be included in base 12.

FIG. 1a schematically shows wet friction material 12 with the binder added to a base material 13. Base material 13 is formed by a plurality of diatomaceous earth particles 14 imbedded in a matrix of fibers 16 between a first outer surface—i.e., an upper outer surface 13a in the view of the figures—and a second outer surface 13b— i.e., a lower outer surface 13a in the view of the figures—of base material 13. Base material 13 may also include one or more friction modifiers.

Fibers 16, particles 14 and any friction modifiers are joined together in a pulping process, which involves forming a mixture of the fibers 16, particles 14 and any friction modifiers submerged together in a liquid solution, then drying the mixture to remove the liquid. After fibers 16 and particles 14 are joined together by the liquid solution, wet friction material 12 includes a matrix formed by fibers 16 and diatomaceous earth particles 14 that define a network of voids.

After fibers 16, particles 14 and any friction modifiers are joined together, base material 13 is saturated with a binder 18, for example in the form of phenolic resin. The binder 18 penetrates past outer surface 13a into the interior of the wet friction material 12 such that voids in the interior of wet friction material 12 are saturated with the binder 18, but the outer surface 13a is exposed.

As schematically shown in FIG. 1b, base material 13, including the binder therein, is then placed on top of a rigid part 30, which may be formed of metal, and the binder saturated base material 13 and part 30 are joined together to form a friction assembly. Prior to joining of layer and part 30, the binder is subject to initial curing to a level called B-stage, where base material 13 is somewhat flexible. The joining of base material 13 and part 30 together includes pressing base material 13 against metal part 30 with a heat plate to complete curing of the binder 24 in forming a cured base material 13, fixing base material 13 and metal part 30 together. The force of pressing of the heat plate against outer surface 13a of base material 13, while inner surface 13b of base material 13 rests on an outer layer 30a of metal part 30, causes the binder to accumulate at an interface of inner surface 13b of base material 13 and outer surface 30a of metal part 30, while the curing of the binder by the heat of the heat plate creates a permanent connection between metal part 30 and base material 13. The binder solidifies and hardens in base material 13 in contact with filler material 14 and fibers 16. In one preferred embodiment, the heat at a surface of the heat plate that contacts outer surface 13a of base material 13 is 375 to 425 degrees F.

As schematically shown in FIG. 1c, a colloidal silica containing solution is then applied to base material 13 to form a colloidal silica coating 20 on the particles 14 and fibers 16 at the outer surface 13a of base material 13. Colloidal silica coating 20 may be applied by spraying, rolling or brushing onto outer surface 13a after base material 13 is cured and attached to metal part 30. During application of colloidal silica coating 20, the colloidal silica containing solution also may drip down into base material 13, covering at least some of particles 14 and fibers 16 in an interior of base material 13 that is formed between outer surfaces 13a, 13b. Colloidal silica coating 20 thus covers at least outer surface 13a, which is defined as a surface in plane of base material 13 that contacts a planar surface that is pressed onto base material 13. For example, the planar surface may be considered as being a part which friction material 12 is pressed against for frictional engagement or which is pressed against friction material 12 for frictional engagement.

The colloidal silica containing solution may include colloidal silica suspended in an aqueous solution. The colloidal silica containing solution may include 30 to 50% by weight of colloidal silica and 50 to 60% by weight of water. The silica particles have a spherical shape that is non-porous. The colloidal silica containing solution may also include other compounds, including an ionic charge modifier. The colloidal silica containing solution may include 2 to 10% by weight of the ionic charge modifier. The ionic charge modifiers may be ethylene glycol or aluminum hydroxide. The colloidal silica containing solution may include 2 to 5% by weight of aluminum hydroxide or 5 to 10% by weight of ethylene glycol.

In one advantageous embodiment, the silica particles have a mean size of 20 to 25 nm. The silica particles may have a specific surface area of 130 to 150 m²/g. The silica particles may have a specific gravity of 1.2 to 1.5.

In one advantageous embodiment, the step of applying the colloidal silica containing solution includes applying 1 to 10 mg/cm2 of the suspension is applied to base material 13 after the binder is cured and the base material 13 is attached to metal part 30.

After the colloidal silica containing solution is applied to the base material 13, the water is removed by drying the colloidal silica containing solution to finalize the formation of colloidal silica coating 20, which defines an upper outer surface 13a of wet friction material 12.

In some advantageous embodiments, colloidal silica layer 20, after drying, includes 60 to 100% by weight of colloidal silica and has a mean thickness of 50 to 125 microns.

In some advantageous embodiments, the binder embedded base material 13 of wet friction material 12 may include, by percent weight, 25 to 45% fibers, 25 to 40% filler material and 25 to 40% binder. More specifically, binder embedded base material 13 of wet friction material 12 may advantageously include, by percent weight, 25 to 45% fibers, 10 to 20% diatomaceous earth, 15 to 30% calcined kaolin clay and 30 to 40% tung oil modified phenolic resin.

The binder embedded base material 13 of wet friction material 12 may advantageously include, by percentage weight, 28 to 38% fibers, 28 to 38% filler material and 30 to 35% binder.

The binder embedded base material 13 of wet friction material 12 may advantageously include, by percent weight, 28 to 38% fibers, 10 to 20% diatomaceous earth, 18 to 28% calcined kaolin clay and 30 to 40% tung oil modified phenolic resin.

In a specific advantageous embodiment, the binder embedded base material 13 of wet friction material 12 may advantageously include, by percent weight, 28 to 38% fibers, 8 to 18% diatomaceous earth, 15 to 25% calcined kaolin clay and 30 to 35% tung oil modified phenolic resin.

In another preferred embodiment, base material 13 of wet friction material 12, after curing, attachment to part 30 and coating with colloidal silica layer 20, may include, by percentage weight, 30 to 45% fibers, 25 to 35% filler material, 1 to 15% friction modifiers and 25 to 40% binder. More specifically, wet friction material 12 may include, by percentage weight, 27 to 42% fibers, 25 to 30% filler material, 1 to 15% friction modifiers and 30 to 35% binder.

In a specific advantageous embodiment, the resin saturated base material 13 may include, by percentage weight, 20 to 35% cellulose fibers, 5 to 15% aramid fibers, 20 to 35% diatomaceous earth, 1 to 5% carbon fibers, 1 to 15% graphite, and 30 to 35% phenolic resin.

In a more specific advantageous embodiment, the resin saturated base material 13 may include, by percentage weight, 25 to 30% cellulose fibers, 5 to 10% aramid fibers, 25 to 35% diatomaceous earth, 2 to 4% carbon fibers, 1 to 5% graphite, and 30 to 35% phenolic resin.

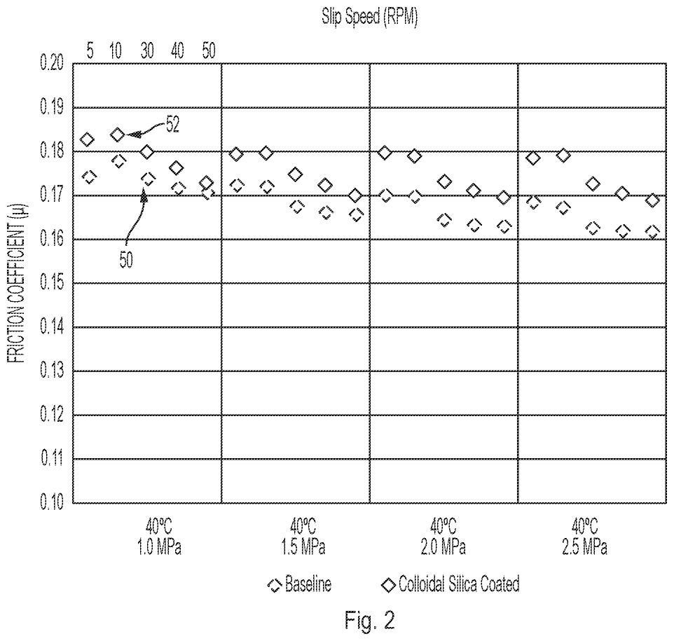

FIG. 2 shows a graph illustrating the advantages of coating the base material 13 with colloidal silica coating 20. The results from FIG. 2 were obtained by testing a colloidal silica coated friction material with a baseline friction material that was constructed in essentially the same manner as the colloidal silica coated friction material, without the colloidal silica coating. FIG. 2 shows a friction versus speed graph illustrating an uncoated friction material 50 and a friction material 52 coated with colloidal silica particles. Uncoated friction material 50, includes, by weight percent, 34% cellulose fibers, 20% calcined kaolin clay, 13% diatomaceous earth and 33% tung modified phenolic resin. The colloidal silica coated material, coated friction material 52, includes, by weight percent, 33% cellulose fibers, 20% calcined kaolin clay, 13% diatomaceous earth and 33% tung modified phenolic resin. For the colloidal silica coated friction material, the colloidal silica suspension was applied to the finished part and allowed to dry fully prior to testing. All of the tests were performed using FORD ultra low viscosity (ULV) automatic transmission fluid, which has a viscosity of 19.2 cSt at 40° C. and 4.5 cSt at 100° C.

As shown in FIG. 2, friction material 52 has a surprisingly greater dynamic friction coefficient than friction material 50 over a variety of speed ranges, solely due to friction material 52 being colloidal silica, across a number of application pressures with a fluid temperature of 40° C.

TABLE 1

| Coated with Colloidal Silica | | | | Uncoated | | | |
|---|---|---|---|---|---|---|---|
| Applied | Temp | Rotational | Friction | Applied | Temp | Rotational | Friction |
| Pressure (MPa) | (C.) | Speed(RPM) | Coefficient | Pressure (MPa) | (C.) | Speed (RPM) | Coefficient |
| 1.0 | 40 | 5 | 0.182 | 1.0 | 40 | 5 | 0.174 |
| | | 10 | 0.183 | | | 10 | 0.178 |
| | | 30 | 0.180 | | | 30 | 0.174 |
| | | 40 | 0.176 | | | 40 | 0.171 |
| | | 50 | 0.173 | | | 50 | 0.170 |
| 1.5 | 40 | 5 | 0.179 | 1.5 | 40 | 5 | 0.172 |
| | | 10 | 0.180 | | | 10 | 0.172 |
| | | 30 | 0.174 | | | 30 | 0.167 |
| | | 40 | 0.172 | | | 40 | 0.166 |
| | | 50 | 0.170 | | | 50 | 0.166 |
| 2.0 | 40 | 5 | 0.180 | 2.0 | 40 | 5 | 0.170 |
| | | 10 | 0.179 | | | 10 | 0.170 |
| | | 30 | 0.173 | | | 30 | 0.164 |
| | | 40 | 0.171 | | | 40 | 0.163 |
| | | 50 | 0.170 | | | 50 | 0.163 |
| 2.5 | 40 | 5 | 0.178 | 2.5 | 40 | 5 | 0.169 |
| | | 10 | 0.179 | | | 10 | 0.168 |
| | | 30 | 0.172 | | | 30 | 0.163 |
| | | 40 | 0.171 | | | 40 | 0.162 |
| | | 50 | 0.169 | | | 50 | 0.162 |

Accordingly, FIG. 2 shows that for a range of 5 RPM to 50 RPM, a range of 1.0 MPa to 2.5 MPa and in a fluid temperature range of 40°, the friction material 52 coated with colloidal surprisingly performs consistently better than the uncoated friction material 50. In particular, the friction material 52 has a friction coefficient range of 0.169 to 0.183 for a range of 5 RPM to 50 RPM, a range of 1.0 MPa to 2.5 MPa and in a fluid temperature of 40°. In contrast, friction material 50 has a friction coefficient range that drops down to 0.162.

Table 1 provides a number of beneficial slip speed and applied pressure ranges, not limited to the specific subsets set forth hereafter.

For a speed of 5 RPM, friction material 52 has a friction coefficient of at least 0.178, and more specifically 0.178 to 0.182 for an applied pressure range of 1.0 to 2.5 MPa.

For a speed of 10 RPM, friction material 52 has a friction coefficient of at least 0.179, and more specifically 0.179 to 0.183 for an applied pressure range of 1.0 to 2.5 MPa.

For a speed range of 5 to 10 RPM, friction material 52 has a friction coefficient at least 0.178, and more specifically 0.178 to 0.183 for an applied pressure range of 1.0 to 2.5 MPa

For a speed of 30 RPM, friction material 52 has a friction coefficient of at least 0.172, and more specifically 0.172 to 0.180 for an applied pressure range of 1.0 to 2.5 MPa.

For a speed of 40 RPM, friction material 52 has a friction coefficient of at least 0.171, and more specifically 0.171 to 0.176 for an applied pressure range of 1.0 to 2.5 MPa.

For a speed of 50 RPM, friction material 52 has a friction coefficient of at least 0.169, and more specifically 0.169 to 0.173 for an applied pressure range of 1.0 to 2.5 MPa.

For a speed range of 30 to 50 RPM, friction material 52 has a friction coefficient of 0.169, and more specifically 0.169 to 0.176 for an applied pressure range of 1.5 to 2.5 MPa.

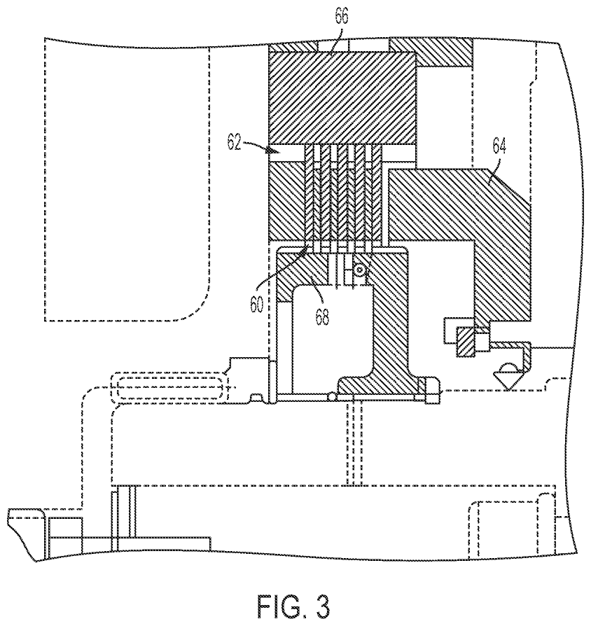

FIG. 3 shows wet friction material layer 12 bonded to a plurality of clutch plates 60 in a clutch pack 62. A piston 64 forces to clutch plates 60 together to couple parts 66, 68 together such that parts 66, 68 rotate together when the clutch pack 62 is engaged.

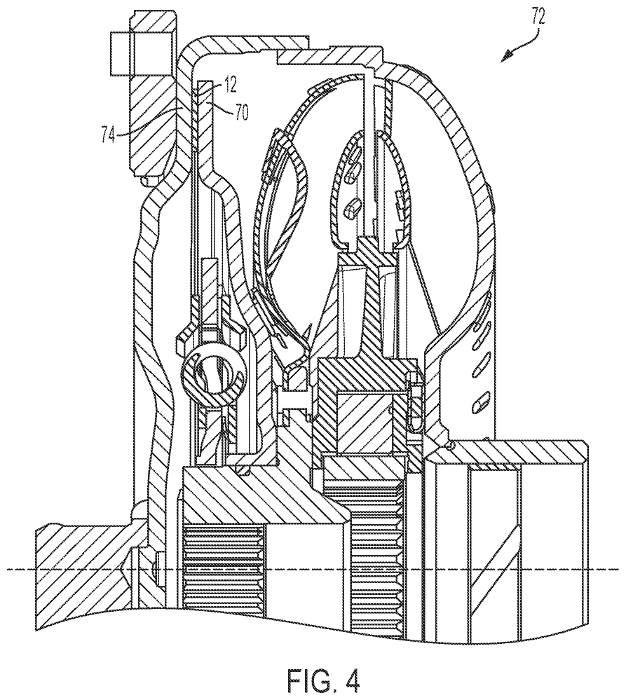

FIG. 4 shows wet friction material layer 12 bonded to a clutch plate 70 in a torque converter 72. Fluid forces to clutch plate 70 against cover 74 such that friction material layer 12 couples clutch plate 70 and cover 74 together such that clutch plate 70 and cover 74 rotate together when the clutch plate 70 is engaged.

In the preceding specification, the disclosure has been described with reference to specific exemplary embodiments and examples thereof. It will, however, be evident that various modifications and changes may be made thereto without departing from the broader spirit and scope of disclosure as set forth in the claims that follow. The specification and drawings are accordingly to be regarded in an illustrative manner rather than a restrictive sense.

### LIST OF REFERENCE NUMERALS

12 wet friction material layer
13 base material
13 a outer surface
13b inner surface
14 filler particles
16 fibers
18 binder
20 colloidal silica coating
30 metal part
30a outer surface
50 uncoated friction material
52 friction material coated with colloidal silica
60 clutch plates
62 clutch pack
64 piston
66, 68 rotating parts
70 clutch plate
72 torque converter
74 cover

What is claimed is:

1. A clutch assembly for a motor vehicle drivetrain comprising:
a rigid support; and
a wet friction material comprising:
a base material including a matrix of fibers and filler particles embedded in the matrix of fibers;
a binder embedded in the base material; and
a colloidal silica coating applied onto an outer surface of the base material.

2. The clutch assembly as recited in claim 1 wherein the binder embedded base material includes, by percent weight, 25 to 45% fibers, 25 to 40% filler material and 25 to 40% binder.

3. The clutch assembly as recited in claim 2 wherein the filler material includes calcined kaolin clay.

4. The clutch assembly as recited in claim 3 wherein the binder embedded base material includes, by percent weight, 25 to 45% fibers, 10 to 20% diatomaceous earth, 15 to 30% calcined kaolin clay and 30 to 40% tung oil modified phenolic resin.

5. The clutch assembly as recited in claim 2 wherein the binder embedded base material includes, by percentage weight, 28 to 38% fibers, 28 to 38% filler material and 30 to 35% binder.

6. The clutch assembly as recited in claim 5 wherein the binder embedded base material includes, by percent weight, 28 to 38% fibers, 10 to 20% diatomaceous earth, 18 to 28% calcined kaolin clay and 30 to 40% tung oil modified phenolic resin.

7. The clutch assembly as recited in claim 5 wherein the binder embedded base material includes, by percent weight, 28 to 38% fibers, 8 to 18% diatomaceous earth, 15 to 25% calcined kaolin clay and 30 to 35% tung oil modified phenolic resin.

8. The clutch assembly as recited in claim 1 wherein the binder embedded base material includes, by percentage weight, 20 to 35% cellulose fibers, 5 to 15% aramid fibers, 20 to 35% diatomaceous earth and/or calcined kaolin clay, 1 to 5% carbon fibers, 1 to 15% graphite, and 30 to 35% phenolic resin.

9. The clutch assembly as recited in claim 4 wherein the binder embedded base material includes, by percentage weight, 25 to 30% cellulose fibers, 5 to 10% aramid fibers, 25 to 35% diatomaceous earth and/or calcined kaolin clay, 2 to 4% carbon fibers, 1 to 5% graphite, and 30 to 35% phenolic resin.

10. The clutch assembly as recited in claim 1 wherein the colloidal silica coating is formed of colloidal silica particles having a mean diameter of 20 to 25 nm.

11. The clutch assembly as recited in claim 1 wherein the wet friction material has a dynamic friction coefficient in a range of 0.17 to 0.18 in automatic transmission fluid having a temperature of 40° C. in a rotational speed range of 5 RPM to 50 RPM and an applied pressure range of 1.0 MPa to 2.5 MPa.

12. A method of making a clutch assembly for a motor vehicle comprising:
fixing a wet friction material to a surface of a rigid support,
the wet friction material being made by:
providing a base material including a matrix of fibers and filler particles and a binder embedded in the matrix of fibers; and
applying a colloidal silica containing solution on an outer surface of the base material to form a colloidal silica coating on the base material.

13. The method as recited in claim 12 wherein the fixing of the wet friction material to the surface of the rigid support includes attaching the base material to the rigid part to provide a cured base material on the rigid part, the colloidal silica containing solution being applied on the outer surface of the base material to form the colloidal silica coating on the cured base material after the attaching of the base material to the rigid part.

14. The method as recited in claim 13 further comprising curing the binder prior to the applying of the colloidal silica containing solution on the outer surface of the base material to form the colloidal silica coating on the base material.

15. The method as recited in claim 12 wherein the colloidal silica containing solution includes, by percent weight, 30 to 50% by weight of colloidal silica and 50 to 60% by weight of water.

16. The method as recited in claim 12 wherein particles of the colloidal silica have a spherical shape and are non-porous.

17. The method as recited in claim 12 wherein particles of the colloidal silica have a mean diameter of 20 to 25 nm.

18. The method as recited in claim 12 wherein the applying of the colloidal silica containing solution on the outer surface of the base material to form the colloidal silica coating on the base material includes applying 1 to 10 mg/cm2 of the suspension the base material.

19. The method as recited in claim 12 wherein the binder embedded base material includes, by percent weight, 25 to 45% fibers, 10 to 20% diatomaceous earth, 15 to 30% calcined kaolin clay and 30 to 40% tung oil modified phenolic resin.
